(19) United States
(12) Patent Application Publication
(10) Pub. No.: US 2013/0056557 A1
(43) Pub. Date: Mar. 7, 2013

(54) Non-pressurized flavored liquid oxygen breath spray device

(71) Applicant: Maggie Blair Felder, Winston Salem, NC (US)

(72) Inventor: Maggie Blair Felder, Winston Salem, NC (US)

(21) Appl. No.: 13/224,365

(22) Filed: Sep. 2, 2011

(51) Int. Cl. B05B 1/00

(52) U.S. Cl. 239/302

(57) ABSTRACT

The present invention is a non-pressurized flavored liquid oxygen breath spray device containing oxygenated breath spray, disclosed for recreational purposes. The present invention integrates the technical fields of breath sprays and portable oxygen units, yielding a unique product that is convenient, healthy and trendy. It comprises of an elongated cylindrical container of flavorful breath spray and extra oxygen, connected to a misting actuator, with a soft, translucent polymeric material surrounding a portion of the misting actuator for oral comfort. The present invention is held horizontally, sprays in the same horizontal fashion into the mouth, and may be held and utilized by the lips, teeth or fingertips. With unique flavors to elicit exquisite taste and smell, the extra oxygen content enriches one's senses for an invigorating sensory experience, new, healthy and fun.

### TECHNICAL FIELD

The present invention integrates the technical fields of breath sprays and portable oxygen units, yielding a new and unique product.

### BACKGROUND OF THE INVENTION

The following information about oxygen benefits must be considered in order to proceed with the related prior art: Additional oxygen benefits all kinds of people as it naturally gives an immediate energy boost, helps the body absorb essential minerals, vitamins, amino acids, enhances cognitive ability, boosts the immune system and contributes to a healthier-looking skin and complexion.

In the field of oxygen inhalation devices, inventors are attempting to popularize the utilization of portable oxygen containers. U.S. Pat. No. 7,204,246, issued to Joseph Berinato entitled, Air Self Contained Oxygen Inhaler, discloses the combination of a breath spray and an asthma inhaler that could be used for health reasons and recreational use. However, it includes an inconvenient nostril attachment for inhalation purposes as well as a pressurized oxygen canister that is combustible.

U.S. Pat. No. 7,341,056 issued to Daniel Tucker entitled, Portable Oxygen Supply Unit, discloses a large portable oxygen supply unit that consists of a container, tilt valve, mounting cap, pressurized oxygen gas and other necessary components for the apparatus.

The portable oxygen supply unit and many other portable, and non-portable, oxygen suppliers include awkward masks, valves, tubes, mouth guards and sprays near the face in order to deliver contents to the user; thus rendering them rather cumbersome and unattractive. Also, most portable oxygen-enriched air suppliers are large vertical devices delivered like spray-paint aerosol canisters and usually require pressurized oxygen canisters that risk combustion.

Thus far, many oxygenating devices are strictly for medicinal, recovery or prevention purposes, and not recreational. Many of the devices are complicated to construct, therefore increasing manufacturing cost. Also, pressurized gas requirements restrain the distribution process as well as the storage process.

The recreational partake in oxygen bars is a novel idea for social gathering around a healthy aromatic oxygen source, but the system limits people's movement and interaction with others as they are restrained by a nasal tube connected to a machine. While people in clubs have found that oxygen increases energy levels and helps them dance all night, the oxygen bar is received in a rather obtrusive and unattractive manner by means of nasal tubing and it simply restricts movement. The oxygen is not portable, flavors are limited, and the process may be further complicated due to possible tube entanglement.

While canned oxygen is portable and gives an energy boost, the device is often only directed towards extreme athletes, seniors, and people with hangovers, headaches or stressed induced symptoms. The oxygen containers come in a limiting range of flavors and are often large cans utilized in a vertical position like an aerosol spray paint canister. The oxygen cans are pressurized, therefore having more manufacturer, distribution, and storage restrictions. Cans expelling a mist towards the face waste oxygen contents into the air, and cans received from a mask are rather socially awkward. Once again the canisters are often too large for the average pocket or purse, and are unappealing in a social gathering, like in a club or at a party.

While such oxygenated products are a good foundation for the business of recreational oxygen use, the range of products are limited by the inconvenience of large containers, the unattractive vertical design of oxygen cans, the risk of combustion due to pressurized canisters, the delivery by way of awkward mouthpieces, tubes and masks, and all such products have limiting or non-unique flavors. The oxygen bar itself simply restrains a person's movement and potential social interaction during use. Overall, the common direction of advertisement limits the range of consumers and overall appeal, as they are directed mostly towards extreme athletes, seniors, people with jet-lag, hang-overs or stressed induced headaches.

In the field of breath sprays, traditional breath sprays are convenient in size, but usually meant for quick use and then kept hidden in a purse or pocket. The dispensers usually spray perpendicular to the cylindrical container and are not meant to be held comfortably in the mouth.

Everyone wants a refreshing taste in their mouth; however, breath sprays lack an assortment of exquisite flavors and lack specific ingredients that will intensify the tasty sensation and benefit one's health even more. While the presentation of breath spray containers are small and convenient, an aesthetic redesign to the containers and the addition of a healthy ingredient will create a new product and set a trend for healthy recreational inhalants and sprays.

In the field of recreational inhalants, the prior art record is replete with different types of recreational smoking inhalation devices, known to be suave, smooth and attractive in movies, however the public is becoming more aware of their health hazards. The common horizontal smoking apparatus that often contains tobacco may solely be held by the lips, teeth or fingertips and is shaped in a sleek cylindrical fashion. The devices are highly popular among young adults who inhale their contents worldwide. To sum up the disadvantages, it has been proven that such smoking devices are extremely hazardous to one's health. While the contents are to be discouraged, the presentation of the slender horizontal cylinder, comfortably set for an oral inhalation, is highly popular and has a familiar shape and manner of use known worldwide.

### BRIEF SUMMARY OF THE INVENTION

The present invention is a non-pressurized flavored liquid oxygen breath spray device containing oxygenated breath spray, disclosed for recreational purposes. The present invention integrates the technical fields of breath sprays and portable oxygen units, yielding a unique product that is convenient, healthy and trendy. The present invention is comprised of a small elongated plastic cylindrical container, containing a liquid mixture of flavored breath spray and liquid oxygen content. The elongated plastic cylindrical container is connected to a nasal spray dispenser, with a soft, translucent polymeric material surrounding a portion of the nasal spray dispenser to make for a comfortable mouthpiece. The present invention may be held by the lips, teeth or fingertips. The non-pressurized flavored liquid oxygen breath spray device is held horizontally and sprays in the same horizontal fashion into the mouth. Upon applied pressure of one's fingertips to the nasal spray dispenser, the device emits the flavored breath spray mixed with the liquid oxygen content, into the mouth from within the elongated cylindrical container. With unique flavors to elicit exquisite taste and smell, the flavored breath spray and liquid oxygen content refreshes the breath and enriches one's senses for a new, pleasant and invigorating sensory experience, healthy and fun.

As the contents of the present invention do not contain pressurized gas, a pressurized container is unnecessary, which appropriately cuts down on manufacturing costs, storage and delivery restrictions. Since the liquid oxygen content inside the container is in liquid form, the non-pressurized flavored liquid oxygen breath spray device does not require a pressurized container, thus making the design of the misting sprayer and container affordable, and easy to manufacture and distribute. The contents within the elongated plastic cylindrical container include a flavored breath spray made with a flavorful tea concentrate, mixed with a certain amount of stabilized liquid oxygen; delivering a refreshing mist of oxygenated breath spray. Once again, the mixture inside the elongated plastic cylindrical container is a liquid, not a pressurized gas. Therefore, the nasal spray dispenser emits a wet mist not a gas.

The purpose of the non-pressurized flavored liquid oxygen breath spray device is to feel refreshed by the flavorful oxygenated mist expelled from the hand-held apparatus. It is shaped and held similarly to that of a cigar, but having entirely different composition and means of operation. Specifically, in one embodiment, the elongated cylindrical container is about 4 inches long and a ½ inch in diameter. It may be plastic or another low cost and efficient material. Most mascara-like elongated plastic cylindrical containers will suffice. Attached to the elongated cylindrical container is a connective misting actuator. A nasal spray dispenser works well because it mists in line with the elongated cylindrical container, easily fits between one's lips or teeth, and is easily operated by the fingertips. The nasal spray dispenser is utilized as an oral mist dispenser. For extra oral comfort, a soft translucent polymeric material encircles the long dispensary portion of the nasal spray dispenser. An opening in the translucent polymeric material remains for the hole of the nasal spray dispenser, wherein the spray is dispensed into the mouth. The soft, translucent polymeric material cushions the nasal spray dispenser to help make for a comfortable mouthpiece.

To utilize the non-pressurized flavored liquid oxygen breath spray device one must dispense the contents from within the container. To do so, the elongated cylindrical container is positioned between his or her fingers, much like a cigar, and the lips or teeth surround the translucent polymeric material that encircles a portion of the nasal spray dispenser. Next, one applies pressure from his or her fingertips to the nasal spray dispenser. With applied pressure from the fingertips onto the nasal spray dispenser, the oxygenated breath spray releases from within the elongated cylindrical container, into the mouth. The non-pressurized flavored liquid oxygen breath spray device is simply activated by the fingertips and sprays into the mouth in a horizontal fashion, just like it is positioned.

The size of the non-pressurized flavored liquid oxygen breath spray device is small and may easily fit into a pocket or purse. It may be used in nightclubs, at home, outside, or anywhere one may want to enjoy a refreshing and healthy, flavorful and oxygenated mist into his or her mouth.

Overall, the device offers visual, tactile, olfactory and gustatory stimulation for a fun and healthy sensory experience, designed with social aesthetics and comfort in mind. In regards to direction of advertisement, the present invention would have a wide range of consumers as it is directed towards most people ages twelve and up.

Conclusively, the present invention is an aesthetically appealing apparatus that engages one in a full sensory experience provided by the device and the contents within the device; consisting of the oxygenated breath spray comprised of a flavorful tea concentrate mixed with a stabilized liquid oxygen content. Also, within the small hand-held or mouth-held device, the oxygen boosts sensory stimulation, which enriches one's experience of the flavor within the spray. The extra oxygen content within the flavored breath spray may also increase the benefits of use; enhancing alertness, energy, memory, reaction, sensations and experience.

It is, therefore, an object of the present invention to provide a non-pressurized flavored liquid oxygen breath spray device which has all of the advantages of the prior art and none of the disadvantages.

It is another object of the present invention to provide a non-pressurized flavored liquid oxygen breath spray device that will evolve the mainstream market of recreational inhalants or sprays for better health.

It is another object of the present invention to provide a non-pressurized flavored liquid oxygen breath spray device which may be easily and efficiently manufactured and marketed.

A further object of the present invention is to provide a non-pressurized flavored liquid oxygen breath spray device which is economically affordable and available for market and the purchasing public.

The present invention is not meant to substitute or imitate any other inventions, or be a means to quit smoking. The present invention stands as itself.

### BRIEF DESCRIPTION OF THE DRAWINGS

FIG. 1 shows a front view of the present invention

FIG. 2 shows a right side view of the present invention and is the mirror image of the left side.

### DRAWINGS—REFERENCE NUMERALS

1 non-pressurized flavored liquid oxygen breath spray device
2 nasal spray dispenser
3 elongated plastic cylindrical container
4 soft translucent polymeric material

### DETAILED DESCRIPTION OF THE INVENTION

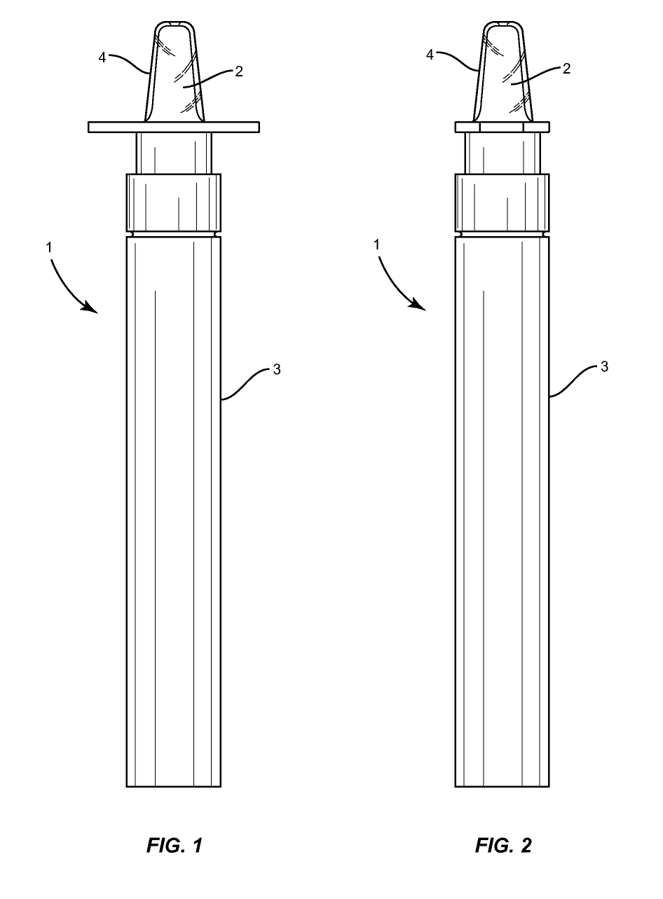

Referring again to FIG. 1, the present invention comprises the non-pressurized flavored liquid oxygen breath spray device 1, which includes the elongated plastic cylindrical container 3, the connective nasal spray dispenser 2, covered in the soft translucent polymeric material 4. The elongated plastic cylindrical container 3 is approximately four inches long and a ½ inch in diameter, attached to the nasal spray dispenser 2 that is about one inch long. The nasal spray dispenser 2 is coated in a soft translucent polymeric material 4, with a hole remaining around the tip of the nasal spray dispenser 2 where the contents of the elongated cylindrical container 3 are released upon applied pressure from the fingertips to the misting nasal spray dispenser 2. Specifically, the soft translucent polymeric material 4 encircles the narrow portion of the nasal spray dispenser 2 and allows for a comfortable oral fit for someone to surround his or her mouth, lips, or teeth around the nasal spray dispenser 2. Once the user properly positions the non-pressurized flavored liquid oxygen breath spray device 1 into the mouth, he or she may expel a mist of the liquid mixture into his or her mouth, which is contained inside the elongated plastic cylindrical container 3, by simply applying pressure to the nasal spray dispenser with the fingertips.

In regards to the elongated plastic cylindrical container 3 wherein the contents are held, the elongated plastic cylindrical container 3 contains a composition of a specific amount of flavored breath spray made with a tea concentrate, dissolved with stabilized liquid oxygen. The non-pressurized flavored liquid oxygen breath spray device 1 is properly held by the lips, teeth, or fingertips at a horizontal plane to meet one's mouth. It is not meant to be operated in a vertical position or utilized inside the nostril.

The non-pressurized flavored liquid oxygen breath spray device 1 is held in a horizontal manner much like a cigar, but sprays a flavored oxygenated breath spray into the mouth for a refreshing taste and an extra oxygen boost. The non-pressurized flavored liquid oxygen breath spray device 1 is simply an elongated cylindrical container 3 attached to an oral misting actuator provided by a nasal spray dispenser 2 that is encapsulated by a soft, translucent polymeric material 4 for oral comfort.

Referring now to FIG. 2 of the non-pressurized flavored liquid oxygen breath spray device 1; more specifically, if an individual wants to utilize the non-pressurized flavored liquid oxygen breath spray device 1, the user holds the device between one's fingertips and surround one's mouth around the oral misting actuator, provided by the nasal spray dispenser 2 coated in the soft translucent polymeric material 4, and then proceeds to operate the device by applying pressure by the fingertips to the nasal spray dispenser 2 in the direction of the attached elongated cylindrical container 3. When one applies pressure from his or her fingertips to the nasal spray dispenser 2, it dispenses the liquid mixture that is contained in the connective elongated plastic cylindrical container 3, as a mist. Once a person applies pressure from the fingertips to the nasal spray dispenser 2, the specific liquid mixture of the oxygenated breath spray composition, from within the elongated cylindrical container 3, will expel in the form of a fresh mist into the mouth.

Ideally, a person would hold the elongated plastic cylindrical container 3 between one's fingertips and rest his or her lips around the soft translucent polymeric material 4 that surrounds the portion of the nasal spray dispenser 2. Pressing the nasal spray dispenser 2 towards the direction of the connective elongated cylindrical container 3 and in the opposite direction of the mouth, the oxygenated breath spray, would spray from the elongated plastic cylindrical container 3 out of the nasal spray dispenser 2, into the mouth.

While the foregoing written description of the invention enables one of ordinary skill to make and use what is considered presently to the best mode thereof, those of ordinary skill will understand and appreciate the existence of variations, combinations, and equivalents of the specific embodiment, method and examples herein. The invention should therefore not be limited by the above described embodiment, method and examples, but by all embodiments and methods within the scope and spirit of the invention as claimed. Additionally, it is important, that if deemed necessary, the present invention may be modified to improve the purpose of the non-pressurized flavored liquid oxygen breath spray device.

1. A non-pressurized flavored liquid oxygen breath spray device for dispensing a composition of flavorful breath spray and liquid oxygen, comprising:
a non-pressurized container;
a composition of flavorful breath spray and liquid oxygen contained in the non-pressurized container;
a misting actuator associated with the non-pressurized container and operative upon actuation to emit a mist of flavorful breath spray and liquid oxygen; and
a material that is relatively soft compared to the misting actuator disposed on at least a portion of the misting actuator.

2. The device of claim 1 wherein the non-pressurized container includes an elongated container.

3. The device of claim 1 wherein the non-pressurized container comprises an elongated cylindrical container constructed of plastic.

4. The device recited in claim 1 wherein the non-pressurized container is held horizontally to meet the mouth.

5. The device of claim 1 wherein the misting actuator is configured to be actuated by applying pressure from the lips, teeth or fingertips of a person.

6. The device of claim 1 wherein the misting actuator includes a nasal spray dispenser.

7. The device of claim 1 wherein the relatively soft material disposed on at least a portion of the misting actuator includes translucent polymeric material.

8. The device of claim 1 wherein the composition includes flavorful breath spray and liquid oxygen and wherein the flavorful breath spray includes a tea concentrate.

9. The device of claim 1 wherein the composition includes flavorful breath spray and liquid oxygen and wherein the liquid oxygen includes a stabilized liquid oxygen content.

10. The device recited in claim 1 wherein the non-pressurized flavored liquid oxygen breath spray device is for oral refreshment.

11. The device recited in claim 1 wherein the flavorful breath spray comes in a variety of different flavors.
